(19) United States
(12) Patent Application Publication
(10) Pub. No.: US 2021/0229647 A1
(43) Pub. Date: Jul. 29, 2021

(54) Hydraulic Unit of a Traction Control System

(71) Applicant: ROBERT BOSCH GMBH, Stuttgard (DE)

(72) Inventors: Alexander GEISSLER-BARTENSCHLAGER, Michelfeld-Gnadental (DE); Oliver GAERTNER, Abstatt (DE)

(73) Assignee: Robert Bosch GmbH, Stuttgart (DE)

(21) Appl. No.: 17/052,879

(22) PCT Filed: Apr. 12, 2019
(86) PCT No.: PCT/EP2019/059582

§ 371 Date: Nov. 4, 2020

(30) Foreign Application Priority Data
Jun. 7, 2018 (DE) 10 2018 209 004.1

(51) Int. Cl. B60T 13/20; B60T 8/176; B60T 13/68; B60T 13/74; B60R 16/03; F16J 15/32

(52) U.S. Cl. CPC B60T 13/20; B60T 8/176; B60T 13/686; B60T 13/745; B60R 16/0231; F16J 15/32; B60T 2270/10; B60T 2270/203; B60T 2270/306; B60R 16/03

(57) ABSTRACT

A hydraulic unit of a traction control system of a hydraulic vehicle brake system includes a hydraulic block and an electric motor that is arranged on the hydraulic block and configured to drive hydraulic pumps of the traction control system. The hydraulic block has a valve side that faces away from the electric motor. Solenoid valves, an electronic control unit and electrical plug contacts in a multiple electrical connector are arranged on the valve side. In order to prevent any liquid that has leaked from the electric motor from reaching the valve side, a hollow shaft, through which connection lines of the electric motor are fed, is sealed in a through-hole, which runs from the electric motor to the valve side facing away, by a sealing ring that consists of acrylonitrile butadiene rubber that swells upon contact with brake fluid.

The invention relates to a hydraulic unit of a brake control system of a hydraulic vehicle brake system having the features of the preamble of claim 1. Slip control systems are, for example, antilock braking, traction control and vehicle dynamics control systems or electronic stability programs, for which the abbreviations ABS, ASR, FDR and ESP are conventional.

### PRIOR ART

German Laid-Open Application DE 10 2006 059 924 A1 discloses a hydraulic block of a hydraulic unit of a slip control system in a hydraulic vehicle brake system. The known hydraulic block is a cuboidal block of metal which is provided with receptacles for solenoid valves, hydraulic pumps, pressure sensors and connections for the attachment of brake lines coming from a brake master cylinder or leading to hydraulic wheel brakes. One of the two large sides of the known hydraulic block is provided for attachment of an electric motor for driving the hydraulic pumps. Electric connection lines of the electric motor are passed through a through hole from the side provided for the attachment of the electric motor to an opposite side of the hydraulic block and are brought into contact there.

### DISCLOSURE OF THE INVENTION

The hydraulic unit according to the invention, having the features of claim 1, is provided for slip control of a hydraulic vehicle brake system. It has a hydraulic block, in particular a cuboidal hydraulic block, and an electric motor, which is arranged on one side of the hydraulic block, also referred to below as the motor side of the hydraulic block. The electric motor serves to drive one or more hydraulic pumps, which are arranged in the hydraulic block for the purpose of generating brake pressure and/or delivering brake fluid. The hydraulic block has a through hole from the motor side to an opposite side, in which an electric connection line for the electric motor is arranged. The connection line is used to supply power to the drive of the electric motor, to a control system, e.g. an electronic commutator of the electric motor, and to transmit signals, e.g. from a rotational speed sensor or a rotational angle sensor of the electric motor, to an electronic control unit of the slip control system. It is preferable if a plurality of or all of the connection lines of the electric motor are passed through the through hole in the hydraulic block. It is also possible for the hydraulic block to have a plurality of through holes for the connection lines of the electric motor, thus enabling connection lines for supplying power to the electric motor to be passed through the hydraulic block from the motor side to the opposite side separately from data, signal and/or control lines, for example. According to the invention, the connection line for the electric motor is sealed off in the through hole in the hydraulic block in order to prevent brake fluid that has accidentally entered the electric motor or reached the motor side of the hydraulic block from reaching the opposite side of the hydraulic block through the through hole in which the connection line is arranged. Sealing also prevents abraded particles of a mechanical commutator of the electric motor or of slip rings for supplying power to a rotor of the electric motor from reaching the opposite side of the hydraulic block through the through hole in the hydraulic block in which the connection line for the electric motor is arranged, for example.

The hydraulic unit according to the invention can also be used as a power braking unit for generating and/or controlling a brake pressure and/or wheel brake pressures for a power braking system in which the brake pressure is generated by the hydraulic unit and not by the muscle power of a vehicle driver. The power braking unit may or may not have a slip control system.

The hydraulic block is used for mechanically fastening and hydraulically connecting components of the slip control system. Such components are the electric motor, the hydraulic pumps, solenoid valves, check valves, hydraulic accumulators, dampers and pressure sensors, for example. The hydraulic block has receptacles for fastening the components and is provided with holes, which may also be referred to as drillings in the hydraulic block, and which connect the components of the slip control system in accordance with a hydraulic circuit diagram of the slip control system. Fitted with the components of the slip control system, the hydraulic block forms the hydraulic unit.

The subject matter of the dependent claims comprises developments and advantageous embodiments of the invention indicated in the independent claim.

Claim 2 envisages that the connection line/s for the electric motor is/are arranged in a hollow shaft which insulates it/them electrically and/or protects it/them from damage. The hollow shaft can be arranged on the electric motor and can be introduced into the through hole in the hydraulic block when the electric motor is mounted on the hydraulic block. The connection line is sealed off in the hollow shaft, and the hollow shaft is sealed off in the through hole of the hydraulic block.

Claim 3 provides a sealing ring for sealing off the connection line in the hollow shaft and/or in the through hole of the hydraulic block, and/or for sealing off the hollow shaft in the through hole of the hydraulic block.

A sealing material by means of which the connection line for the electric motor is sealed off in the through hole of the hydraulic block and/or in the hollow shaft, and/or the hollow shaft is sealed off in the through hole of the hydraulic block preferably swells in the event of contact with brake fluid (claim 4). This means that the sealing material increases in volume due to contact with brake fluid, with the result that it is pressed more strongly against a sealing surface and seals more effectively. It is also possible originally for there to be a gap between the sealing material and the sealing surface which is closed and sealed off by the swelling of the sealing material when it comes into contact with the brake fluid. If there is a sealing ring for sealing, the sealing ring in this embodiment of the invention is composed of the sealing material which swells in the event of contact with the brake fluid. It is not envisaged that brake fluid will get into the through hole of the hydraulic block or into the hollow shaft and come into contact with the sealing material there. The sealing is provided for the case where brake fluid accidentally comes into contact with the sealing material.

A suitable sealing material for sealing off the connection line for the electric motor in the through hole of the hydraulic block and/or in the hollow shaft and/or for sealing off the hollow shaft in the through hole of the hydraulic block is, for example, acrylonitrile-butadiene rubber, for which the abbreviation NBR for nitrile butadiene rubber is known.

All the features disclosed in the description and the drawing can be implemented individually or in fundamentally any combination in illustrative embodiments of the invention. Embodiments of the invention which do not have all but only one or more features of a claim are possible in principle.

### BRIEF DESCRIPTION OF THE DRAWING

The invention is explained in greater detail below by means of an embodiment illustrated in the drawing. In the drawing:

FIG. 1 shows a simplified and schematized side view of a hydraulic unit according to the invention; and

FIG. 2 shows an enlarged illustration of a detail indicated by the circle II in FIG. 1.

### EMBODIMENT OF THE INVENTION

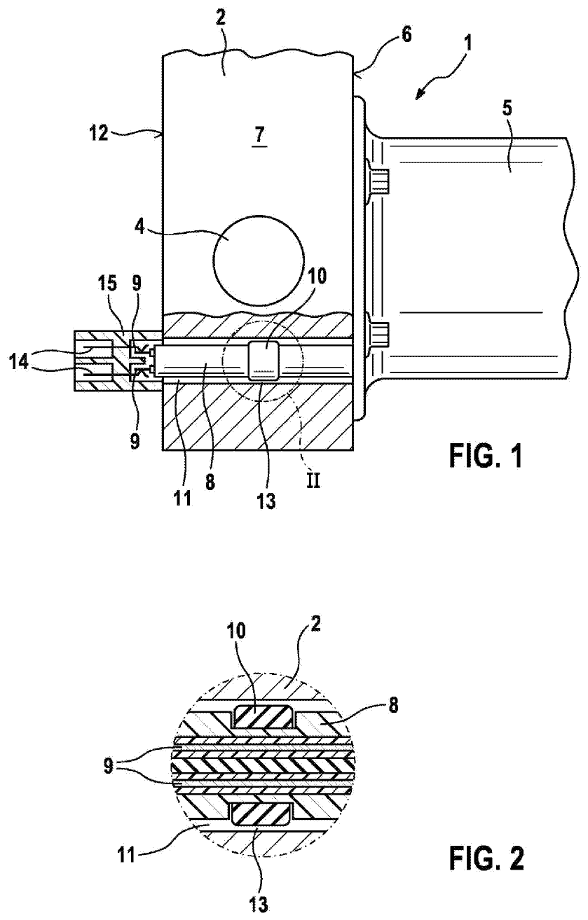

The hydraulic unit 1 according to the invention which is illustrated in FIG. 1 is provided for a slip control system of a vehicle brake system, which is not otherwise illustrated. Known slip control systems are antilock braking, traction control and vehicle dynamics control systems, wherein the latter are also referred to as electronic stability programs and colloquially also as antiskid control systems. The abbreviations ABS, ASR and FDR/ESP are conventional for these slip control systems. They are known and are not explained here. Power braking processes and brake pressure control processes within power braking processes are also possible with the hydraulic unit 1 according to the invention. These enumerations are illustrative and not exclusive.

The hydraulic unit 1 has a hydraulic block 2 which, in the embodiment of the invention which is depicted and described, is a flat, cuboidal metal block composed, for example, of an aluminum alloy. The hydraulic block 2 is used for mechanically fastening and hydraulically interconnecting components of the slip control system, such as solenoid valves, check valves, hydraulic accumulators, damper chambers, hydraulic pumps 4 and an electric motor 5 for driving the hydraulic pumps 4. The hydraulic block 2 is provided with blind holes (not visible in the drawing), some of them with stepped diameters, as receptacles for the solenoid valves, the hydraulic pumps 4, check valves, hydraulic accumulators and damper chambers and connections for the connection of brake lines (not illustrated) from a brake master cylinder and to hydraulic wheel brakes with screw-fastening or press-in nipples (“self-clinch”), which are connected to one another by holes within the hydraulic block 2 in accordance with a hydraulic circuit diagram of the slip control system.

Mounted on the outside on a flat side of the hydraulic block 2 is the electric motor 5, the motor shaft of which (not visible in the drawing) projects into an eccentric chamber (likewise not visible in the drawing) in the hydraulic block 2 and there has an eccentric for driving the hydraulic pumps 4. The flat sides are the mutually opposite large sides of the hydraulic block 2. The flat side on which the electric motor 5 is mounted is referred to here as the motor side 6.

Two hydraulic pumps 4 are arranged in pump receptacles coaxially opposite one another, which are mounted in two longitudinal sides of the hydraulic block 2 and open radially into the eccentric chamber. The longitudinal sides of the hydraulic block 2 that have the pump receptacles are referred to here as pump sides 7. In the embodiment illustrated and described, the hydraulic pumps 4 are piston pumps, which can also be interpreted as pump elements.

The electric motor 5 has a hollow shaft 8 in the form of a cylindrical tube which projects eccentrically and in an axially parallel manner from one end of the electric motor 5, by means of which the electric motor 5 is mounted on the hydraulic block 2. Connection lines 9 of the electric motor 5 are passed through the hollow shaft 8. The connection lines 9 are used to supply power to the electric motor 5. In addition, connection lines 9 for an electronic commutator of the electric motor 5, insofar as said motor is an electronically commutated electric motor 5, and connection lines 9 as signal, sensor and/or data lines, e.g. for an angle sensor of the electric motor 5, can be passed through the hollow shaft 8. In the enlarged detailed illustration in FIG. 2, the hollow shaft 8 is illustrated in an axial section, and therefore the connection lines 9 are visible.

The hollow shaft 8 with the connection lines 9 passes through a through hole 11, which passes perpendicularly to the motor side 6 through the hydraulic block 2 to the opposite flat side of the hydraulic block 2, which is referred to here as the valve side 12. The hollow shaft 8 is sealed off in the through hole 11 by means of a sealing ring 10, which is arranged in an encircling groove on the hollow shaft 8. The sealing ring 10 is composed of acrylonitrile-butadiene rubber (nitrile rubber for short; English: nitrile butadiene rubber, abbreviation: NBR), i.e. of a sealing material which swells, that is to say increases in volume, in contact with brake fluid. In general, the sealing ring 10 is composed of a sealing material which swells in contact with brake fluid, that is to say that the hollow shaft 8 with the connection lines 9 of the electric motor 5 is sealed off in the through hole 11 of the hydraulic block 2 by means of a sealing material which swells in contact with brake fluid. The figure depicts a sealing ring 10 of rectangular ring cross section, but other sealing rings, such as O-rings or quad rings, can also be used.

On the inside, the hollow shaft 8 is filled with a sealing material that surrounds the connection lines 9, with the result that the hollow shaft 8 is also sealed off on the inside, as are the connection lines 9. The sealing material in the hollow shaft 8 can likewise be a sealing material which swells in contact with brake fluid, that is to say, for example, likewise acrylonitrile-butadiene rubber.

The purpose of sealing off the hollow shaft 8 in the through hole 11 of the hydraulic block 2 and sealing off the hollow shaft 8 on the inside and the passed-through connection lines 9 in the hollow shaft 8 is to ensure that no brake fluid gets from the motor side 6 of the hydraulic block 2 or from the electric motor 5 to the valve side 12 of the hydraulic block 2 through the through hole 11 through which the hollow shaft 8 with the connection lines 9 for the electric motor 5 passes.

Such brake fluid is not intended and not wanted and, in the event of a leak, can get out of the hydraulic pumps 4 into the eccentric chamber between the pump receptacles and, out of the latter, into the electric motor 5 as “leakage fluid”. The sealing of the hollow shaft 8 of the electric motor 5 on the outside and on the inside also seals off the through hole 11 in the hydraulic block 2 against the passage of particles, which can arise, for example, as abraded material from electric sliding contacts (“brush abrasion”) in the electric motor 5 if, for example, the electric motor 5 is mechanically commutated and/or has sliding contacts for supplying power to its rotor.

The sealing ring 10 of the hollow shaft 8 for passing through the connection lines 9 of the electric motor 5 can rest sealingly in the through hole 11 in the hydraulic block 2 when it is not swollen. In this case, the sealing ring 10 presses more strongly inward against the hollow shaft 10 and more strongly outward against the through hole 11 when it swells through contact with the brake fluid, thereby improving sealing. In the illustrated and described embodiment of the invention, there is a gap 13 between the sealing ring 10 and the through hole 11 when the sealing ring 10 is not swollen. This simplifies assembly of the hydraulic unit 1 because, during mounting of the electric motor 5 on the hydraulic block 2, the hollow shaft 8 can be inserted more easily through the through hole 11 and the hydraulic block 2, and damage to the sealing ring 10 is avoided. When the sealing ring 10 swells owing to contact with brake fluid, it forms a reliable seal.

On a side remote from the electric motor 5, the connection lines 9 project in an insulated manner from the hollow shaft 8 and are connected in an electrically conducting manner to the plug contacts 14 arranged in a multiple electrical connector 15, e.g. in a multipoint connector on the valve side 12 of the hydraulic block 2. The multipoint connector 15 has not only the plug contacts 14 for the electric motor 5 but also further plug contacts 14 for the solenoid valves and for pressure sensors. The solenoid valves, which are not visible in the drawing, are arranged on the valve side 12 of the hydraulic block 2. Solenoid valves arranged at some other location on the hydraulic block 2 are not excluded. Moreover, an electronic control unit (not depicted) for slip control is arranged on the valve side 12 of the hydraulic block 2, for which the multipoint connector 15 likewise has plug contacts 14. In general, the plug contacts 14 can also be interpreted as connection contacts.

The invention avoids brake fluid getting through the through hole 11 in the hydraulic block 2 for the connection lines 9 of the electric motor 5 of the hydraulic unit 1 from the motor side 6 or from the electric motor 5 to the opposite valve side 12, where electromechanical components, namely magnet coils of the solenoid valves, and an electronic system, namely the electronic control unit of the slip control system, and the electric connections, namely the multipoint connector with the plug contacts 14, are arranged.

1. A hydraulic unit of a slip control system of a hydraulic vehicle brake system, comprising:
a hydraulic block, on which an electric motor is arranged on a motor side, the electric motor configured to drive a hydraulic pump arranged in the hydraulic block; and
a connection line that is configured for the electric motor and that passes through a through hole in the hydraulic block from the motor side to an opposite side of the hydraulic block, the connection line sealed off in the through hole in the hydraulic block.

2. The hydraulic unit as claimed in claim 1, wherein the connection line is arranged in a manner sealed off in a hollow shaft, the hollow shaft arranged and sealed off in the through hole of the hydraulic block.

3. The hydraulic unit as claimed in claim 1, wherein one or more of (i) the connection line is sealed off by a sealing ring in one or more of the hollow shaft and the through hole of the hydraulic block, and (ii) the hollow shaft is sealed off by a sealing ring in the through hole of the hydraulic block.

4. The hydraulic unit as claimed in claim 2, wherein one or more of the connection line and the hollow shaft is sealed off by a sealing material that swells in contact with brake fluid.

5. The hydraulic unit as claimed in one or more of the preceding claim 2, wherein one or more of the connection line and the hollow shaft is sealed off by acrylonitrile-butadiene rubber.

6. The hydraulic unit as claimed in claim 1, wherein the connection line is connected in an electrically conducting manner to a connection contact on the opposite side of the hydraulic block from the motor side.

7. The hydraulic unit as claimed in claim 1, wherein a multiple electrical connector is arranged on the opposite side of the hydraulic block from the motor side, the connector having a connection contact to which the connection line is connected in an electrically conducting manner.

8. The hydraulic unit as claimed in claim 1, wherein one or more of an electronic control unit configured for slip control and solenoid valves of the slip control system are arranged on the opposite side of the hydraulic block from the motor side.
